(19) United States
(12) Patent Application Publication
(10) Pub. No.: US 2013/0328947 A1
(43) Pub. Date: Dec. 12, 2013

(54) DISPLAY SYSTEM AND DISPLAY METHOD

(71) Applicant: SEIKO EPSON CORPORATION, Tokyo (JP)

(72) Inventor: Masaki ISHIKAWA, Kunitachi-shi (JP)

(73) Assignee: SEIKO EPSON CORPORATION, Tokyo (JP)

(21) Appl. No.: 13/909,596

(22) Filed: Jun. 4, 2013

(30) Foreign Application Priority Data
Jun. 12, 2012 (JP) 2012-132948
Apr. 17, 2013 (JP) 2013-086350

(51) Int. Cl. G09G 3/20

(52) U.S. Cl. CPC G09G 3/2003
USPC 345/690

(57) ABSTRACT

A display system includes a first image data generation section that generates first image data from color image data inputted, a second image data generation section that generates second image data by area coverage modulation of the first image data and a display processing section that performs a processing to display an image on an electronic paper based on the second image data. The first data generation section performs a processing to expand a difference between the luminance of a first pixel in the color image data and the luminance of a second pixel adjoining the first pixel.

The entire disclosures of Japan Patent Application No. 2012-132948, filed Jun. 12, 2012 and No. 2013-86350, filed Apr. 17, 2013 are expressly incorporated by reference herein.

### BACKGROUND

1. Technical Field

Several aspects of the present invention relates to display systems, display programs, and display methods.

2. Related Art

Electronic paper, such as, EPD (Electrophoretic Display) and the like that can electrically rewritten the display contents, while offering some of the advantages of hard-copy media represented by paper media, have been developed. Some of the characteristics of EPD include better readability and less eye fatigue, compared with CRT (Cathode Ray Tube), LCD (Liquid Crystal Display), and other display devices that are commonly used with modern personal computers, the ability to bend, and excellent portability.

The majority of electronic paper that have been put in practical use display images using two colors of black and white. For this reason, for displaying a color image with electronic paper, it is necessary to convert the image into an image in binary values of black and white.

Meanwhile, for outputting a color image by a monochrome printer, various technologies for converting a color image into binary values of black and white have been described (Patent Document 1). See, for example, Japanese laid-open patent application 2009-005331.

When a color image is converted into binary values of black and white, characters and other images expressed by intermediate gradations may become hardly readable.

### SUMMARY

In accordance with some aspects of the invention, there are provided a display system, a display program, and a display method by which characters and other images expressed by intermediate gradations can be made readily readable. The invention can be implemented according to embodiments or application examples to be described below.

A display system according to an aspect of the invention includes a first image data generation section that generates first image data from color image data of a color image inputted, a second image data generation section that generates second image data by area coverage modulation of the first image data, and a display processing section that performs a processing to display an image on an electronic paper based on the second image data. The first data generation section performs a processing to expand a difference between the luminance of a first pixel in the color image data and the luminance of a second pixel adjoining the first pixel.

In the display system described above, the luminance value of the first pixel in the first image data may preferably be a value calculated through adding, to the luminance value of the first pixel in the color image data, a value obtained based on the luminance value of the first pixel in the color image data and luminance values of plural pixels around the first pixel in the color image data.

In the display system described above, the first pixel may preferably be a pixel at an outer edge of a predetermined figure in the color image and the first image, and the second pixel may preferably be a pixel adjoining the first pixel outside the predetermined figure.

A display program according to another aspect of the invention renders a computer to function as a first image data generation section that generates first image data from color image data of a color image inputted, a second image data generation section that generates second image data by area coverage modulation of the first image data, and a display processing section that performs a processing to display an image on an electronic paper based on the second image data. The first data generation section performs a processing to expand a difference between the luminance of a first pixel in the color image data and the luminance of a second pixel adjoining the first pixel.

In the display program described above, the luminance value of the first pixel in the first image data may preferably be a value calculated through adding, to the luminance value of the first pixel in the color image data, a value obtained based on the luminance value of the first pixel in the color image data and luminance values of plural pixels around the first pixel in the color image data.

In the display program described above, the first pixel may preferably be a pixel at an outer edge of a predetermined figure in the color image and the first image, and the second pixel may preferably be a pixel adjoining the first pixel outside the predetermined figure.

A display method according to another aspect of the invention includes first step of generating first image data from color image data inputted, second step of generating second image data by area coverage modulation of the first image data, and third step of performing a processing to display an image on an electronic paper based on the second image data. The first step performs a processing to expand a difference between the luminance of a first pixel in the color image data and the luminance of a second pixel adjoining the first pixel.

In the display method described above, the luminance value of the first pixel in the first image data may preferably be a value calculated through adding, to the luminance value of the first pixel in the color image data, a value obtained based on the luminance value of the first pixel in the color image data and luminance values of plural pixels around the first pixel in the color image data.

In the display method described above, the first pixel may preferably be a pixel at an outer edge of a predetermined figure in the color image and the first image, and the second pixel may preferably be a pixel adjoining the first pixel outside the predetermined figure.

### Application Example 1

A display system according to the application example 1 includes a first image data generation section that generates first image data in which a difference between the luminance of an outer edge pixel that is a pixel at an outer edge of a figure included in a color image and the luminance of an externally adjacent pixel that is a pixel adjoining the outer edge pixel outside of the figure is enlarged by a given value than data of the color image, a second image data generation section that generates second image data by area coverage modulation of the first image data, and a display processing section that performs a processing to display an image on an electronic paper based on the second image data. According to an aspect of the application example 1, the first image data generation section decides the given value based on a difference between the luminance of the outer edge pixel and the luminance of a pixel adjoining the outer edge pixel.

According to this application example, an image is displayed on an electronic paper based on second image data generated by area coverage modulation of first image data, the first image data being generated through enlarging a difference between the luminance of an outer edge pixel of a figure included in a color image and the luminance of an externally adjacent pixel by a given value than that of data of the color image. Therefore, an image of a figure expressed by intermediate gradation with its contour being emphasized can be displayed. Accordingly, a display system by which characters and the like expressed by intermediate gradation are readily readable can be realized.

Also, the luminance input and output characteristics of an electronic paper are normally not in direct proportion. For this reason, the first image data generation section decides a given value based on a difference between the luminance of an outer edge pixel and the luminance of a pixel adjoining the outer edge pixel, whereby a display system that can control generation of a figure with artificially emphasized contour can be realized.

### Application Example 2

A display program according to the application example 2 renders a computer to function as a first image data generation section that generates first image data in which a difference between the luminance of an outer edge pixel that is a pixel at an outer edge of a figure included in a color image and the luminance of an externally adjacent pixel that is a pixel adjoining the outer edge pixel outside of the figure is enlarged by a given value than data of the color image, a second image data generation section that generates second image data by area coverage modulation of the first image data, and a display processing section that performs a processing to display an image on an electronic paper based on the second image data. According to an aspect of the application example 2, the first image data generation section decides the given value based on a difference between the luminance of the outer edge pixel and the luminance of a pixel adjoining the outer edge pixel.

According to this application example, an image is displayed on an electronic paper based on second image data generated by area coverage modulation of first image data, the first image data being generated through enlarging a difference between the luminance of an outer edge pixel of a figure included in a color image and the luminance of an externally adjacent pixel by a given value than that of data of the color image. Therefore, an image of a figure expressed by intermediate gradation with its contour being emphasized can be displayed. Accordingly, a display program by which characters and the like expressed by intermediate gradation are readily readable can be realized.

Note that the luminance input and output characteristics of an electronic paper are not normally in direct proportion. For this reason, the first image data generation section, which is executed by, for example, a computer that forms a part of a display device including an electronic paper, or a computer connected through a communication wire with a display device including an electronic paper, decides a given value based on a difference between the luminance of an outer edge pixel and the luminance of a pixel adjoining the outer edge pixel, whereby a display program that realizes a display system capable of suppressing generation of a figure with artificially emphasized contour can be achieved.

### Application Example 3

A display method according to the application example 2 includes first image data generation step of generating first image data in which a difference between the luminance of an outer edge pixel that is a pixel at an outer edge of a figure included in a color image and the luminance of an externally adjacent pixel that is a pixel adjoining the outer edge pixel outside of the figure is enlarged by a given value than data of the color image, second image data generation step of generating second image data by area coverage modulation of the first image data, and display processing step of performing a processing to display an image on an electronic paper based on the second image data. According to an aspect of the application example 3, the first image data generation step includes deciding the given value based on a difference between the luminance of the outer edge pixel and the luminance of a pixel adjoining the outer edge pixel.

According to this application example, an image is displayed on an electronic paper based on second image data generated by area coverage modulation of first image data, the first image data being generated through enlarging a difference between the luminance of an outer edge pixel of a figure included in a color image and the luminance of an externally adjacent pixel by a given value than that of data of the color image. Therefore, an image of a figure expressed by intermediate gradation with its contour being emphasized can be displayed. Accordingly, a display method by which characters and the like expressed by intermediate gradation are readily readable can be realized.

Note that the luminance input and output characteristics of an electronic paper are not normally in direct proportion. For this reason, in the first image data generation step, a given value is decided based on a difference between the luminance of an outer edge pixel and the luminance of a pixel adjoining the outer edge pixel, whereby a display method capable of suppressing generation of a figure with artificially emphasized contour can be realized, compared to the case where a fixe value is used for the given value.

### BRIEF DESCRIPTION OF THE DRAWINGS

FIG. 1 is a functional block diagram of a display system 1 in accordance with an embodiment of the invention.

FIG. 2 is a diagram showing an exemplary composition of a display system 2 that expresses the display system 1 more concretely.

FIG. 3 is a flow chart for describing a display method in accordance with an embodiment of the invention.

FIG. 4A and FIG. 4B are illustrations for describing a figure included in a color image C1 and positional relation between outer edge pixels, inner pixels and externally adjacent pixels.

FIG. 5 is an illustration for describing the arrangement of pixels in data of the color image C1.

FIG. 6 is an illustration showing a coefficient image according to a first concrete example.

FIG. 7 is an illustration showing an example of a color image C1.

FIG. 8 is an illustration showing an example of first image data D1 that is generated from the color image C1 shown in FIG. 7.

FIG. 9A is an illustration showing an image that is area-coverage modulated based on the first image data D1, and FIG. 9B is an illustration showing an image that is area-coverage modulated based on the color image C1.

FIG. 10 is an illustration showing a coefficient image according to a second concrete example.

### DESCRIPTION OF EXEMPLARY EMBODIMENTS

Preferred embodiments of the invention are described in detail below with reference to the accompanying drawings. The drawings to be used are provided for the convenience of description. It is noted that the embodiments described below would not limit the content of the invention recited in the scope of the patent claims. Furthermore, all of the compositions to be described below may not necessarily be indispensable compositions of the invention.

Embodiments of the invention will be described according to the following order.

1. Overall Configuration of Display System, Program and Display Method.

2. Concrete examples of processing by First Image Data Generation Section.

2-1. First Concrete Example

2-2. Second Concrete Example

### 1. Overall Configuration of Display System, Program and Display Method

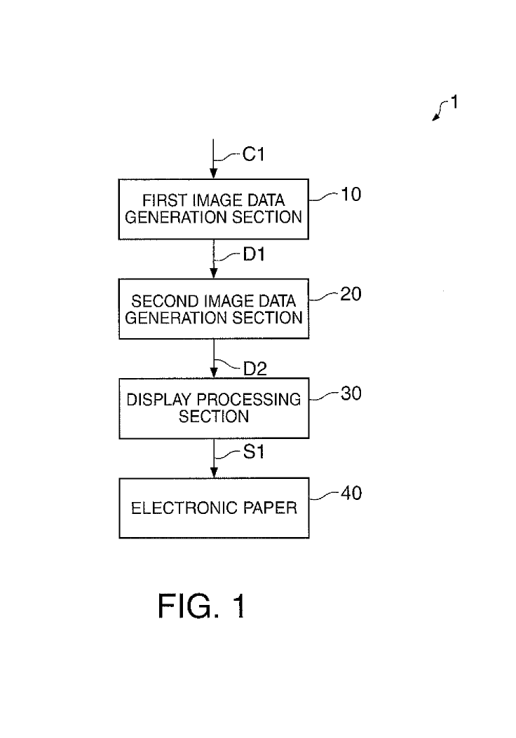

FIG. 1 is a functional block diagram of a display system 1 in accordance with an embodiment of the invention.

The display system 1 according to the present embodiment includes a first image data generation section 10, a second image data generation section 20, a display processing section 30 and an electronic paper 40.

The first image data generation section 10 generates first image data D1 in which a difference between the luminance of an outer edge pixel, that is a pixel at an outer edge of a figure included in a color image C1, and the luminance of an externally adjacent pixel, that is a pixel adjoining the outer edge pixel outside the figure, is made greater enlarged by a given value E1 than that of data of the color image C1.

The first image data generation section 10 decides the given value E1 based on a difference between the luminance of the outer edge pixel and the luminance of a pixel adjoining the outer edge pixel.

The processing performed by the first image data generation section 10 will be described in detail in one of the sections below, “2. Concrete Example of Processing by First Image Data Generation Section.”

The second image data generation section 20 generates second image data D2 by area coverage modulation of the first image data D1 that is generated by the first image data generation section 10. The second image data generation section 20 may use any one of various known methods, such as, a dither method, a density pattern method, or the like, to area-coverage modulate the first image data D1 to generate the second image data D2.

The display processing section 30 performs a processing to display an image on the electronic paper 40 based on the second image data D2 generated by the second image data generation section 20. In the example shown in FIG. 1, the display processing section 30 outputs a control signal S1 generated based on the second image data D2 to the electronic paper 40, thereby processing to display an image on the electronic paper 40.

The electronic paper 40 may be a display module or a display device that incorporates an electronic paper of anyone of various types, such as, electrophoretic type, microcapsule type, electronic liquid powder type, liquid crystal type, electrowetting type, and chemical reaction type.

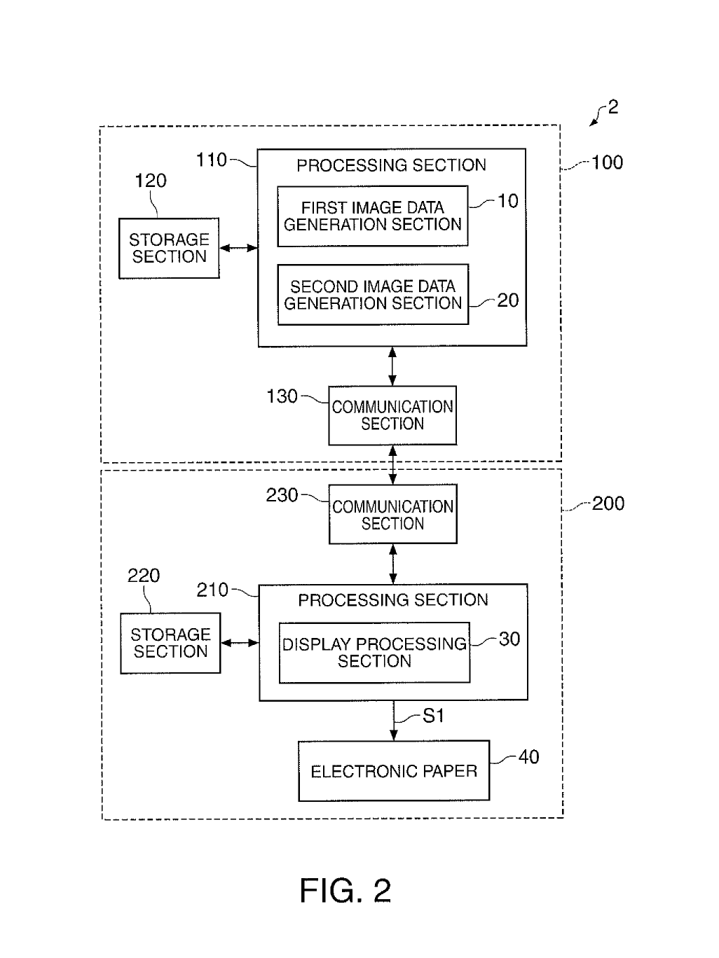

FIG. 2 is a diagram showing an exemplary composition of a display system 2 that more concretely expresses the display system 1. The display system 1 shown in FIG. 2 is configured with a personal computer 100 and a display device 200.

The personal computer 100 is configured with a processing section 110, a storage section 120, and a communication section 130. The display device 200 is configured with a processing section 210, a storage section 220, a communication section 230 and an electronic paper 40.

In the example shown in FIG. 2, the first image data generation section 10 and the second image data generation section 20 are composed as a part of the processing section 110. The processing section 110 may be composed of, for example, a CPU (Central Processing Unit) . It is noted that the first image data generation section 10 and the second image data generation section 20 may be realized by a dedicated electronic circuit, or may be realized by using a program to be executed by the CPU. Also, at least one of the first image data generation section 10 and the second image data generation section 20 may be composed as a part of the processing section 210.

The storage section 120 may function as a temporary working area for process to be performed by the processing section 110, or function as a storage device for storing a color image C1. Note that the color image C1 may be inputted from an external device (not shown) provided externally to the personal computer 100.

The communication section 130 has a function to provide interface for communications with the outside of the personal computer 100 through a communication line.

In the example shown in FIG. 2, the display processing section 30 is composed as a part of the processing section 210. The processing section 210 may be composed of a CPU, for example. The processing section 210 outputs a control signal S1, thereby controlling the electronic paper 40. Note that the display processing section 30 may be realized by a dedicated electronic circuit, or may be realized by using a program executed by the CPU.

The storage section 220 may function as a temporary working area for processes to be executed by the processing section 210.

The communication section 230 has a function to provide interface for communications with the outside of the display device 200 through a communication line.

In the example shown in FIG. 2, the personal computer 100 and the display device 200 are connected through the communication section 130 and the communication section 230. The communication section 130 and the communication section 230 may be any of various known communication lines, such as, USB (Universal Serial Bus) and the like.

In the example shown in FIG. 2, the first image data generation section 10 and the second image data generation section 20 are composed as apart of the personal computer 100. Also, in accordance with the present embodiment, the display processing section 30 is composed as apart of the display device 200 that includes the electronic paper 40. However, the invention is not limited to the above and, for example, the entirety of the first image data generation section 10, the second image data generation section 20 and the display processing section 30 may be composed as a part of the display device 200.

According to the display system 1 and the display system 2 in accordance with the present embodiment, an image is displayed on the electronic paper 40 based on the second image data D2 generated by area coverage modulation of the first image data D1, the first image data D1 being generated through enlarging a difference between the luminance of an outer edge pixel of a figure included in a color image C1 and the luminance of an externally adjacent pixel by a given value E1 than that of data of the color image C1. Therefore, an image of a figure expressed by intermediate gradation whose contour is emphasized can be displayed. Accordingly, a display system by which characters and the like expressed by intermediate gradation are readily readable can be realized.

Also, the luminance input and output characteristics of the electronic paper 40 are normally not in direct proportion. For this reason, the first image data generation section 10 decides the given value E1 based on a difference between the luminance of an outer edge pixel and the luminance of a pixel adjoining the outer edge pixel, whereby a display system that can better control generation of an artificially emphasized contour in a figure, compared with the case of using a fixed value as the given value E1, can be realized.

Note that the first image data generation section 10, the second image data generation section 20 and the display processing section 30 may be realized by a program. More specifically, the present embodiment may be realized by a display program that renders a computer to function as the first image data generation section 10 that generates first image data D1 in which a difference between the luminance of an outer edge pixel that is a pixel at an outer edge of a figure included in the color image C1 and the luminance of an externally adjacent pixel that is a pixel adjoining the outer edge pixel outside of the figure is enlarged by a given value E1 than that of data of the color image C1, the second image data generation section 20 that generates second image data D2 by area coverage modulation of the first image data D1, and the display processing section 30 that performs a processing to display an image on the electronic paper 40 based on the second image data D2.

In this case also, the first image data generation section 10 decides the given value E1 based on a difference between the luminance of the outer edge pixel and the luminance of a pixel adjoining the outer edge pixel.

According to the display program in accordance with the present embodiment, an image is displayed on the electronic paper 40 based on the second image data D2 generated by area coverage modulation of the first image data D1, the first image data D1 being generated through enlarging a difference between the luminance of an outer edge pixel of a figure included in the color image C1 and the luminance of an externally adjacent pixel by the given value E1 than that of data of the color image C1. Therefore, an image of a figure expressed by intermediate gradation with its contour being emphasized can be displayed. Accordingly, a display program by which characters and the like expressed by intermediate gradation are readily readable can be realized.

Also, the luminance input and output characteristics of the electronic paper 40 are not normally in direct proportion. For this reason, the first image data generation section 10, which is executed by, for example, a computer that forms a part of the display device 200 including the electronic paper 40, or a computer connected (i.e., the personal computer 100) through a communication line with the display device 200 including the electronic paper 40, decides the given value E1 based on a difference between the luminance of an outer edge pixel and the luminance of a pixel adjoining the outer edge pixel, whereby a display program that can better control generation of an artificially emphasized contour in a figure, compared with the case of using a fixed value as the given value E1, can be realized

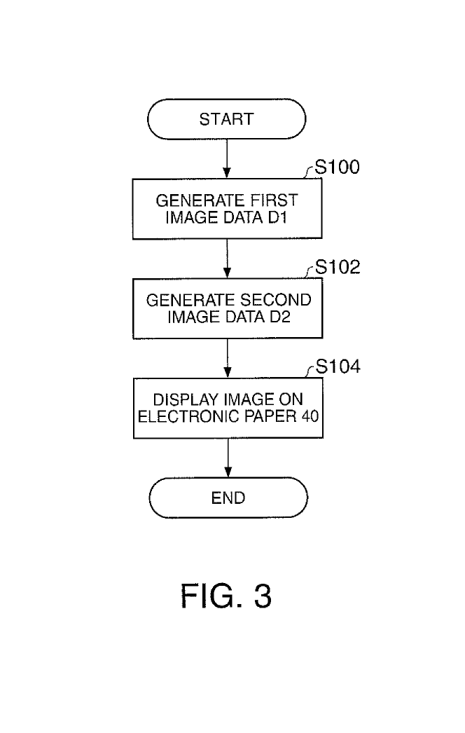

FIG. 3 is a flow chart for describing the display method in accordance with the present embodiment. In the following, the display method in accordance with the present embodiment that is realized by using the display system 1 shown in FIG. 1 will be described.

The display method according to the present embodiment includes first image data generation step (step S100) of generating first image data D1 in which a difference between the luminance of an outer edge pixel that is a pixel at an outer edge of a figure included in a color image C1 and the luminance of an externally adjacent pixel that is a pixel adjoining the outer edge pixel outside the figure is enlarged by a given value E1 than that of data of the color image C1, second image data generation step (step S102) of generating second image data D2 by area coverage modulation of the first image data D1, and display processing step (step S104) of performing a processing to display an image on the electronic paper 40 based on the second image data D2.

As shown in FIG. 3, the first image data generation step (step S100) is executed to generate first image data D1 in which a difference between the luminance of an outer edge pixel that is a pixel at an outer edge of a figure included in a color image C1 and the luminance of an externally adjacent pixel that is a pixel adjoining the outer edge pixel outside of the figure is enlarged by a given value E1 than that of data of the color image C1. In the present embodiment, the first image data generation section 10 executes the first image data generation step.

In the first image data generation step, the given value E1 is decided based on a difference between the luminance of an outer edge pixel and the luminance of a pixel adjoining the outer edge pixel.

After step S100, the second image data generation step (step S102) is executed to generate the second image data D2 by area coverage modulation of the first image data D1. In the present embodiment, the second image data generation section 20 generates the second image data.

After step S102, the display processing step (step S104) is executed to perform a processing to display an image on the electronic paper 40 based on the second image data D2. In the present embodiment, the display processing section 30 executes the display processing step.

According to the display method in accordance with the present embodiment, an image is displayed on the electronic paper 40 based on the second image data D2 generated by area coverage modulation of the first image data D1, the first image data being generated through enlarging a difference between the luminance of an outer edge pixel of a figure included in the color image C1 and the luminance of an externally adjacent pixel by the given value E1 than that of the color image data C1. Therefore, an image of a figure that is expressed by intermediate gradation can be displayed with its contour being emphasized. Accordingly, a display method by which characters and the like expressed by intermediate gradation are readily readable can be realized.

Note that the luminance input and output characteristics of the electronic paper 40 are not normally in direct proportion. For this reason, in the first image data generation step step S100), the given value is decided based on a difference between the luminance of an outer edge pixel and the luminance of a pixel adjoining the outer edge pixel, whereby a display method that can better control generation of an artificially emphasized contour in a figure, compared with the case of using a fixed value as the given value E1, can be realized.

### 2. Concrete Example of Processing by First Image Data Generation Section

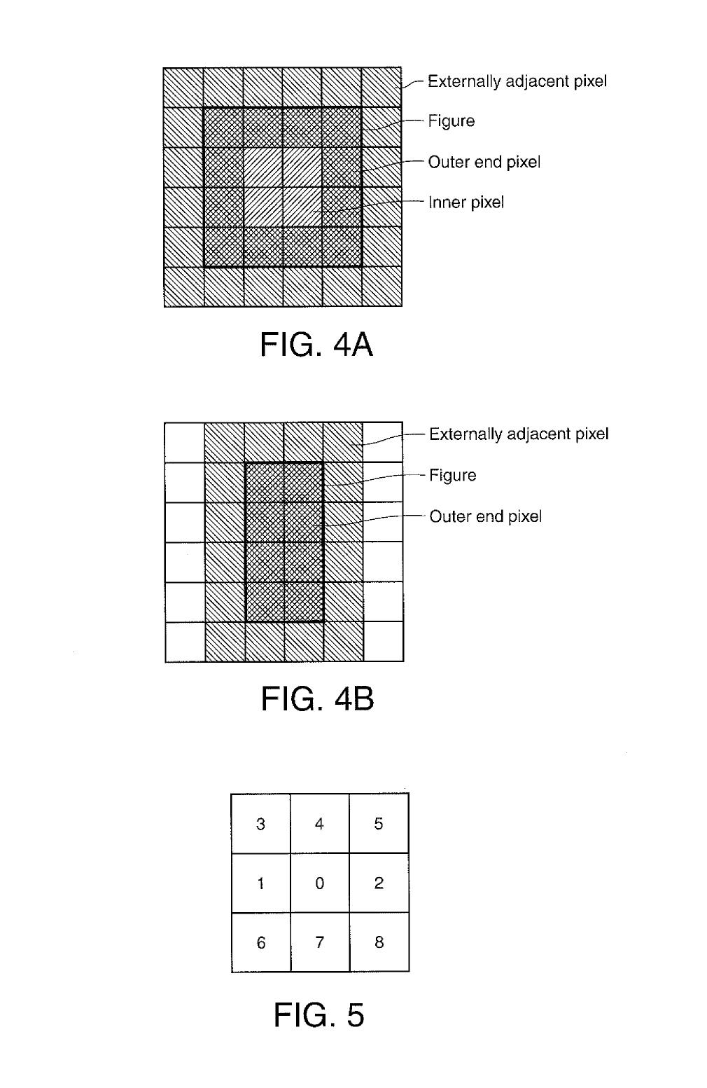

Next, a concrete example of processing by the first image data generation section 10 will be described. FIG. 4A and FIG. 4B are illustrations for describing a figure included in the color image C1 and positional relation between outer edge pixels, inner pixels and externally adjacent pixels.

In FIG. 4A and FIG. 4B, a figure corresponds to a region defined inside a thick solid line. In FIG. 4A and FIG. 4B, outer edge pixels are pixels shaded by mesh. In FIG. 4A and FIG. 4B, inner pixels are pixels shaded by oblique lines oriented to lower left. In FIG. 4A and FIG. 4B, externally adjacent pixels are pixels shaded by oblique lines oriented to lower right. Each of the pixels corresponds to each one pixel (the minimum element having color information) in data of the color image C1.

As shown in FIG. 4A and FIG. 4B, the outer edge pixels are pixels that are inside the figure, and contact the outer edge of the figure. The inner pixels are pixels that are inside the figure but do not contact the outer edge of the figure. The externally adjacent pixels are pixels that adjoin the outer edge pixels, and outside the figure.

FIG. 4A shows an example of a figure that is composed of outer edge pixels and inner pixels. FIG. 4B shows an example of a figure that is composed of outer edge pixels alone.

FIG. 5 is an illustration for describing the arrangement of pixels in data of the color image C1. In FIG. 5, the 0^{th} pixel that is subject to processing by the process in the first image data generation section 10 is indicated as “0.” Similarly, the first pixel that is a pixel on the left side of the 0^{th} pixel is indicated as “1,” the second pixel that is a pixel on the right side of the 0^{th} pixel is indicated as “2,” the third pixel that is a pixel on the upper left side of the 0^{th} pixel is indicated as “3,” the fourth pixel that is a pixel above and adjoining the 0^{th} pixel is indicated as “4,” the fifth pixel that is a pixel on the upper right side of the 0^{th} pixel is indicated as “5,” the sixth pixel that is a pixel on the lower left side of the 0^{th} pixel is indicated as “6,” the seventh pixel that is a pixel below and adjoining the 0^{th} pixel is indicated as “7,” and the eighth pixel that is a pixel on the lower right side of the 0^{th} pixel is indicated as “8.”

In the following description of the concrete example, it is assumed that the luminance of the 0^{th} pixel is y0, the luminance of the first pixel is y1, the luminance of the second pixel is y2, the luminance of the thirdpixel is y3, the luminance of the fourth pixel is y4, the luminance of the fifth pixel is y5, the luminance of the sixth pixel is y6, and luminance of the seventh pixel is y7, and the luminance of the eighth pixel is y8.

### 2-1 First Concrete Example

In the first concrete example, an example of the method, in which the first image data generation section 10 decides a given value E1 based on a difference between the luminance of an outer edge pixel and the luminance of pixels adjoining the outer edge pixel, will be described.

The luminance ynew of the 0^{th} pixel after the processing by the first image data generation section 10 is given by the expression (1) as follows:

ynew=y0+Δy (1)

In the present example, the first image data generation section 10 calculates Δy, using the following expression (2):

Δy={4×y0−(y4+y1+y2+y7)}×0.5 (2)

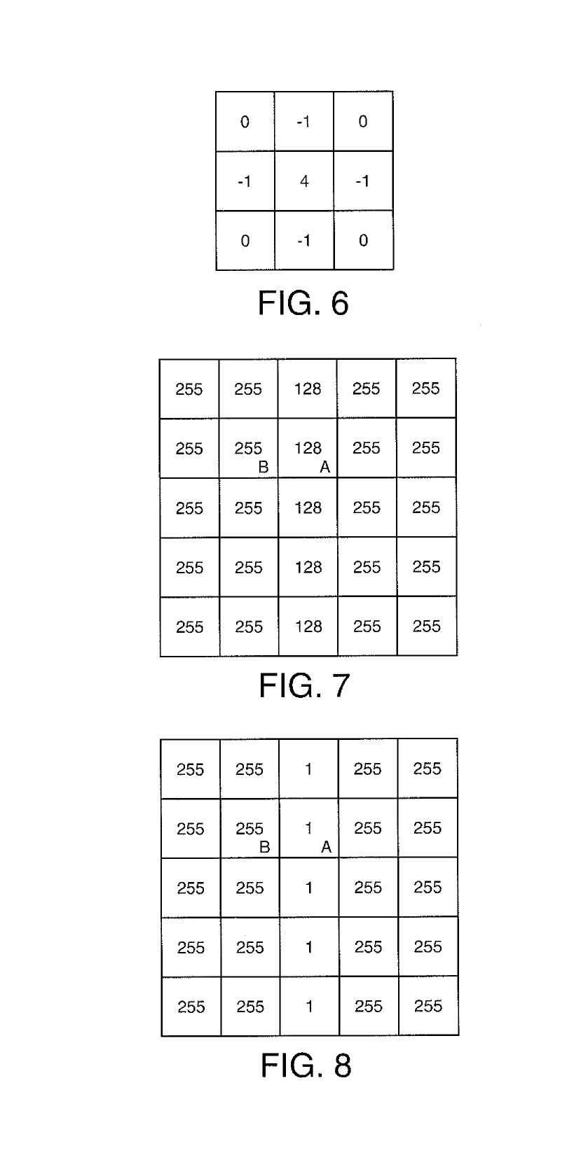

FIG. 6 is an illustration showing a coefficient image in the first concrete example. In FIG. 6, the smallest frame corresponds to each of the pixels. In FIG. 6, pixels are arranged in the same manner as shown in FIG. 5, and coefficients of the corresponding pixels are shown inside the frames, respectively. As shown by the expression (2) and FIG. 6, in accordance with the present example, Δy is calculated based on the difference between the luminance of the 0^{th} pixel and the luminance of pixels adjoining the 0^{th} pixel (the first pixel, the second pixel, the fourth pixel and the seventh pixel).

FIG. 7 is an illustration showing an example of the color image C1. In FIG. 7, the luminance of each of the pixels is shown in each of the frames. In the example shown in FIG. 7, the luminance of each of the pixels is represented in the range between 0 and 255. It is assumed that a pixel A is an outer edge pixel, and a pixel B is an externally adjacent pixel.

When the pixel A shown in FIG. 7, that is the outer edge pixel, is assumed to be the 0^{th} pixel, and the luminance of each of the pixels is substituted for the expression (2), the following expression (3) can be given.

Δy={4×128−(128+255+255+128)}×0.5=−127 (3)

By substituting the expression (3) for the expression (1), the following expression (4) is given.

ynew=128−127=1 (4)

Therefore, the luminance of the pixels A in the first image data D1 becomes to be 1.

When the pixel B shown in FIG. 7, that is the externally adjacent pixel, is assumed to be the 0^{th} pixel, and the luminance of each of the pixels is substituted for the expression (2), and the result is rounded down to the nearest decimal, the following expression (5) is given.

Δy={4×255−(255+255+128+255)}×0.5=63 (5)

By substituting the expression (5) for the expression (1), the following expression (6) is given, as the upper limit of ynew is 255.

ynew=255+63=255 (6)

Therefore, the luminance of the pixels B in the first image data D1 becomes to be 255.

FIG. 8 shows an example of the first image data D1 that is generated from the color image C1 shown in FIG. 7. FIG. 8 shows pixels arranged in the same manner as shown in FIG. 7, and the luminance of each of the pixels is shown in each of the frames, respectively. In the example shown in FIG. 8, the luminance of each of the pixels is represented in the range between 0 and 255.

In the color image C1 shown in FIG. 7, the difference between the luminance of the pixel A that is an outer edge pixel and the luminance of the pixel B that is an externally adjacent pixel is 127. On the other hand, in the image data Dl shown in FIG. 8, the difference between the luminance of the pixel A that is an outer edge pixel and the luminance of the pixel B that is an externally adjacent pixel is 254. In other words, by the process executed by the first image data generation section 10, the difference between the luminance of the pixel A that is an outer edge pixel and the luminance of the pixel B that is an externally adjacent pixel becomes greater by a given value of E1=126.

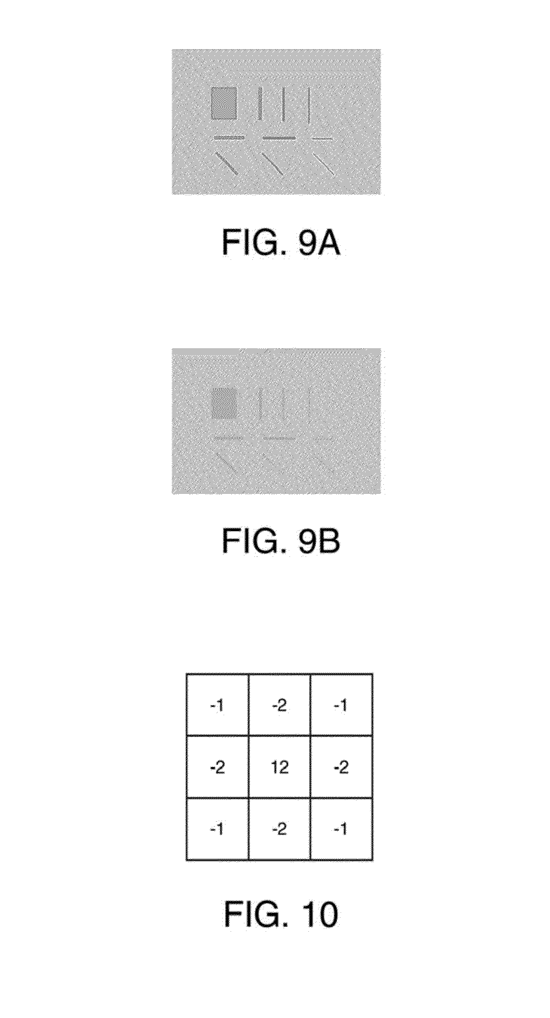

FIG. 9A is an illustration showing an image that is area-coverage modulated based on the first image data D1, and FIG. 9B is an illustration showing an image that is area-coverage modulated based on the color image C1. By comparison between the figure shown in FIG. 9A and the figure shown in FIG. 9B, it is understood that the figure shown in FIG. 9A is more readily readable as its contour is emphasized.

As shown above by the present example, an image of a figure expressed by intermediate gradation can be displayed with its contour being emphasized. Accordingly, a display system, a display program and a display method, by which characters and other figures expressed by intermediate gradation are readily readable, can be realized.

### 2-2. Second Concrete Example

In the second concrete example, an example of the method, in which the first image data generation section 10 decides a given value E1 based on a difference between the luminance of an outer edge pixel and the luminance of a pixel adjoining the outer edge pixel, will be described.

In the second concrete example, the first image data generation section 10 calculates Δy, using the following expression (7), instead of the expression (2):

Δy={12×y0−((y4+y1+y2+y7)×2+(y3+y5+y6+y8))}×0.125 (7)

FIG. 10 is an illustration showing a coefficient image in the second concrete example. In FIG. 10, the smallest frame corresponds to each of the pixels. In FIG. 10, pixels are arranged in the same manner as shown in FIG. 5, and coefficients of the corresponding pixels are shown inside the frames, respectively. As shown by the expression (7) and FIG. 10, in accordance with the present example, Δy is calculated based on the difference between the luminance of the 0^{th} pixel and the luminance of pixels adjoining the 0^{th} pixel (the first pixel, the second pixel, the third pixel, the fourth pixel, the fifth pixel, the sixth pixel, the seventh pixel and the eighth pixel) .

When the pixel A shown in FIG. 7, that is the outer edge pixel, is assumed to be the 0^{th} pixel, and the luminance of each of the pixels is substituted for the expression (7), the following expression (8) can be given.

Δy={12×128−((128+255+255+128)×2+(255+255+255 30 255))}×0.125=−127 (8)

By substituting the expression (8) for the expression (1), the following expression (9) is given.

ynew=128−127=1 (9)

Therefore, the luminance of the pixels A in the first image data D1 becomes to be 1.

When the pixel B shown in FIG. 7, that is the externally adjacent pixel, is assumed to be the 0^{th} pixel, and the luminance of each of the pixels is substituted for the expression (7), and the result is rounded down to the nearest decimal, which gives the following expression (10).

Δy={12×255−((255+255+128+255)×2+(255+128+255+128))}×0.125=63 (10)

By substituting the expression (10) for the expression (1), the following expression (11) is given, as the upper limit of ynew is 255.

ynew=255+63=255 (11)

Therefore, the luminance of the pixels B in the first image data D1 becomes to be 255.

Also in the second concrete example, the first image data D1 that is generated from the color image C1 shown in FIG. 7 becomes to be the one shown in FIG. 8.

In the color image C1 shown in FIG. 7, the difference between the luminance of the pixel A that is an outer edge pixel and the luminance of the pixel B that is an externally adjacent pixel is 127. On the other hand, in the image data D1 shown in FIG. 8, the difference between the luminance of the pixel A that is an outer edge pixel and the luminance of the pixel B that is an externally adjacent pixel is 254. In other words, by the process executed by the first image data generation section 10, the difference between the luminance of the pixel A that is an outer edge pixel and the luminance of the pixel B that is an externally adjacent pixel becomes greater by a given value of E1=126.

As shown above by the present example, an image of a figure expressed by intermediate gradation can be displayed with its contour being emphasized. Accordingly, a display system, a display program and a display method, by which characters and other figures expressed by intermediate gradation are readily readable, can be realized.

Note that the embodiments and the modification examples described above are only examples, and do not limit the invention. For example, each of the embodiments and the modification examples may be combined with others.

The invention is not limited to the embodiments and concrete examples described above, and many modifications can be made. For example, the invention may include compositions that are substantially the same as the compositions described in the embodiments (for example, a composition with the same function, method and result, or a composition with the same objects and result). Also, the invention includes compositions in which portions not essential in the compositions described in the embodiments are replaced with others. Also, the invention includes compositions that achieve the same functions and effects or achieve the same objects of those of the compositions described in the embodiments. Furthermore, the invention includes compositions that include publicly known technology added to the compositions described in the embodiments.

What is claimed is:

1. A display system comprising:
a first image data generation section that generates first image data from color image data inputted;
a second image data generation section that generates second image data by area coverage modulation of the first image data; and
a display processing section that performs a processing to display an image on an electronic paper based on the second image data,
the first data generation section processing to expand a difference between the luminance of a first pixel in the color image data and the luminance of a second pixel adjoining the first pixel.

2. The display system according to claim 1, wherein the luminance value of the first pixel in the first image data is a value calculated through adding, to the luminance value of the first pixel in the color image data, a value obtained based on the luminance value of the first pixel in the color image data and luminance values of plural pixels around the first pixel in the color image data.

3. The display system according to claim 2, wherein the first pixel is a pixel at an outer edge of a predetermined figure in the color image and the first image, and the second pixel is a pixel adjoining the first pixel outside the predetermined figure.

4. A display method comprising:
generating first image data from color image data inputted;
generating second image data by area coverage modulation of the first image data; and
processing to display an image on an electronic paper based on the second image data,
the generating of the first image data including a processing to expand a difference between the luminance of a first pixel in the color image data and the luminance of a second pixel adjoining the first pixel.

5. The display method according to claim 4, wherein the luminance value of the first pixel in the first image data is a value calculated through adding, to the luminance value of the first pixel in the color image data, a value obtained based on the luminance value of the first pixel in the color image data and luminance values of plural pixels around the first pixel in the color image data.

6. The display method according to claim 5, wherein the first pixel is a pixel at an outer edge of a predetermined figure in the color image and the first image, and the second pixel is a pixel adjoining the first pixel outside the predetermined figure.
